(19) United States
(12) Patent Application Publication
(10) Pub. No.: US 2026/0340115 A1
(43) Pub. Date: Oct. 29, 2026

(54) INFORMATION HANDLING SYSTEM WITH AN ELECTROMECHANICAL SWITCH

(71) Applicant: DELL PRODUCTS L.P., Round Rock, TX (US)

(72) Inventors: Kevin W. Mundt, Livingston, TX (US); Sandor Farkas, Round Rock, TX (US); Stephen Strickland, Foxborough, MA (US); Walter R. Carver, Round Rock, TX (US); Timothy M. Lambert, Austin, TX (US)

(21) Appl. No.: 19/189,980

(22) Filed: Apr. 25, 2025

(51) Int. Cl. G06F 21/55

(52) U.S. Cl. CPC G06F 21/554; G06F 2221/034

(57) ABSTRACT

An intrusion detection component detects whether an intrusion has occurred into an information handling system. The intrusion detection component includes a relay, a magnet, and a plunger. The relay includes a switch having multiple contacts, and a core coupled to the switch. The magnet selectively energizes the core of the relay. The plunger is located in proximity to the relay. The plunger changes whether the magnet is in a position to energize the core. In response a transition of the plunger from a retracted position to an extended position, the relay changes the state of the contacts in the switch. The change of the state indicates an intrusion into the information handling system.

### FIELD OF THE DISCLOSURE

The present disclosure generally relates to information handling systems, and more particularly relates to an information handling system with an electromechanical switch.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An intrusion detection component detects whether an intrusion has occurred into an information handling system. The intrusion detection component includes a relay, a magnet, and a plunger. The relay includes a switch having multiple contacts, and a core coupled to the switch. The magnet may selectively energize the core of the relay. The plunger may be located in proximity to the relay. The plunger may change whether the magnet is in a position to energize the core. In response to the transition of the plunger from a retracted position to an extended position, the relay may change the state of the contacts in the switch. The change of the state may indicate an intrusion into the information handling system.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a portion of an information handling system according to at least one embodiment of the present disclosure;

FIG. 2 is a block diagram of a portion of an information handling system with a plunger of an intrusion detection in a closed position according to at least one embodiment of the present disclosure;

FIG. 3 is a block diagram of a portion of an information handling system with a plunger of an intrusion detection in an open position according to at least one embodiment of the present disclosure;

FIGS. 4-6 are diagrams of an intrusion detection component in open and closed states according to at least one embodiment of the present disclosure;

FIGS. 7 and 8 are diagrams of an intrusion detection component in a non-latching configuration according to at least one embodiment of the present disclosure;

FIGS. 9-11 are diagrams of an intrusion detection component in another non-latching configuration according to at least one embodiment of the present disclosure;

FIG. 12 is a sequence of steps during an intrusion detection in an information handling system according to at least one embodiment of the present disclosure;

FIG. 13 is a diagram of a portion of an information handling system including an intrusion detection component in communication with a baseboard management component according to at least one embodiment of the present disclosure;

FIGS. 14 and 15 are diagrams of a portion of an information handling system with different arrangements of an intrusion detection component in a latching relay configuration according to at least one embodiment of the present disclosure;

FIGS. 16 and 17 are diagrams of a portion of an information handling system with different arrangements of an intrusion detection component in a non-latching relay configuration according to at least one embodiment of the present disclosure;

FIG. 18 is a flow diagram of a method for determining whether an intrusion of an information handling system has occurred according to at least one embodiment of the present disclosure;

FIG. 19 is a flow diagram of a method for resetting relay switch in intrusion detection componentry of an information handling system according to at least one embodiment of the present disclosure; and

FIG. 20 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

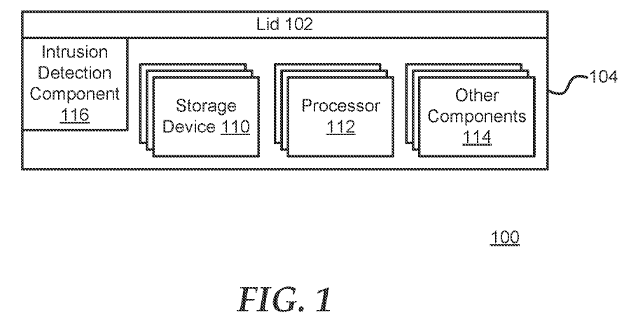

FIG. 1 illustrates a portion of an information handling system 100, such as a server, according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen, and/or a video display. The information handling system may also include one or more buses operable to transmit communications between the various hardware components.

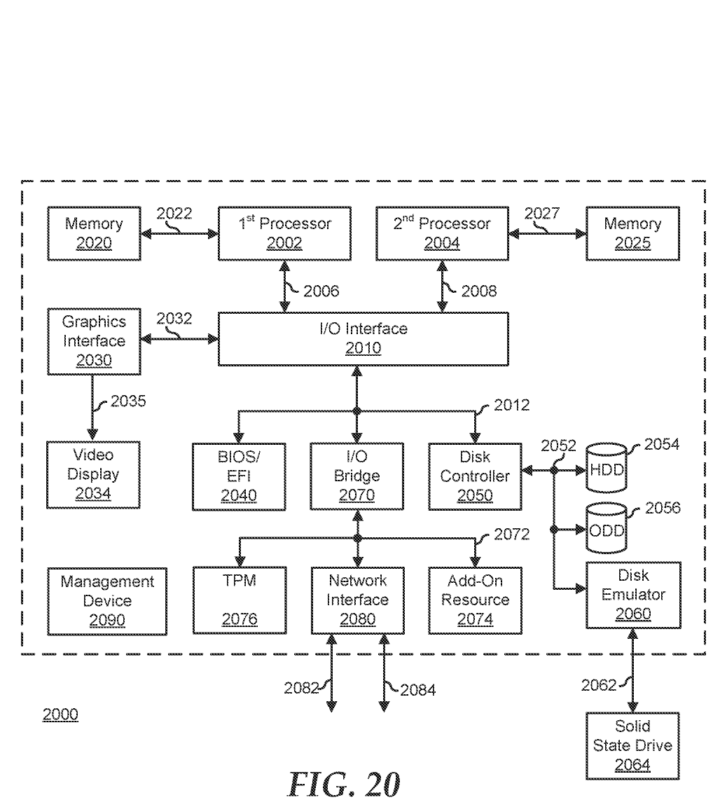

Information handling system 100 includes a lid 102 and a chassis 104. In an example, any suitable number of components may be located within chassis 104. For example, information handling system 100 may include multiple storage devices 110, multiple processors 112, other components 114, and an intrusion detection component 116. In certain examples, intrusion detection component 116 may be located at a particular location within chassis 104 such that the intrusion detection component is end one end of lid 102 as illustrated in FIG. 1. Information handling system 100 may include additional components, such as the components of information handling system 2000 in FIG. 20, without varying from the scope of this disclosure.

In different situations, an individual may remove lid 102 from chassis 104 to gain access to storage devices 110, processor 112, or other components 114. For example, the individual may remove lid 102 to take one or more storage devices 110, processor 112, or other components 114. In this situation, information handling system 100 may not work as intended or the individual may gain access to data stored on one of storage devices 110. In another situation, the individual may leave the physical components but may tamper with storage devices 110, processor 112, or other components 114. In an example, intrusion detection component 116 may determine and store whether lid 102 has been removed from chassis 104. Intrusion detection component 116 may make this determination while information handling system 100 is both powered on and powered off.

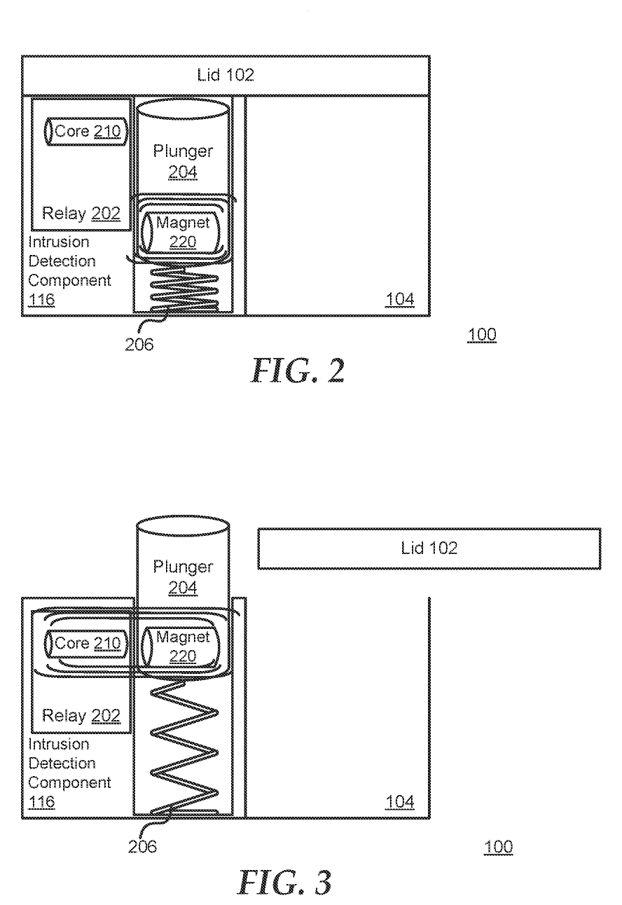

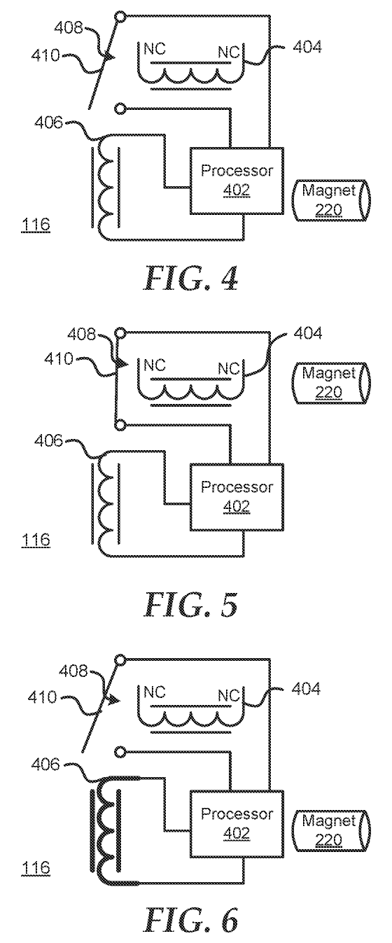

FIGS. 2 and 3 illustrate a portion of information handling system 100 according to at least one embodiment of the present disclosure. Intrusion detection component 116 includes a relay 202, a plunger 204, and a spring 206. Relay 202 includes a core 210. In an example, core 210 may be any type of ferrous core. Plunger 204 includes a magnet 220. In an example, plunger 204 may be proximate to relay 202. Intrusion detection component 116 may include additional components without varying from the scope of this disclosure.

Referring to FIG. 2, information handling system 100 is in a closed state, such that lid 102 is located on all edges of chassis 104. While lid 102 is in this position, an individual may not be able to access components, such as storage devices 110, processor 112, and other components 114 of FIG. 1, within chassis 104. In an example, intrusion detection component 116 may be located within chassis 104 such that it is proximate to lid 102. Based on the location of intrusion detection component 116, the top surface of plunger 204 may be in physical contact with the bottom surface of lid 102 when the lid is closed on chassis 104.

In an example, plunger 204 and spring 206 may be located within a channel of intrusion detection component 116. In this example, spring 206 may be located between the bottom of the channel and the bottom surface of plunger 204. While lid 102 is located on chassis 104, plunger 204 may be in a retracted position such that spring 206 is compressed. In certain examples, spring 206 may exert a force on plunger 204 in the direction of lid 102. However, lid 102 may hold or force plunger 204 to remain in the retracted position while the lid is closed on chassis 104. While plunger 204 is in the retracted position, magnet 220 may be located away from core 210 and the magnet may not have a strong enough magnetic field to energize the core.

Referring to FIG. 3, in response to lid 102 being removed from chassis 104, spring 206 may exert a force on plunger 204 to move the plunger within the channel in the direction the lid was previously located on the chassis. In this situation, plunger 204 may be located in an extended position and information handling system 100 may be in an open position. While plunger 204 is in the extended position, magnet 220 may be located substantially near core 210 of relay 202.

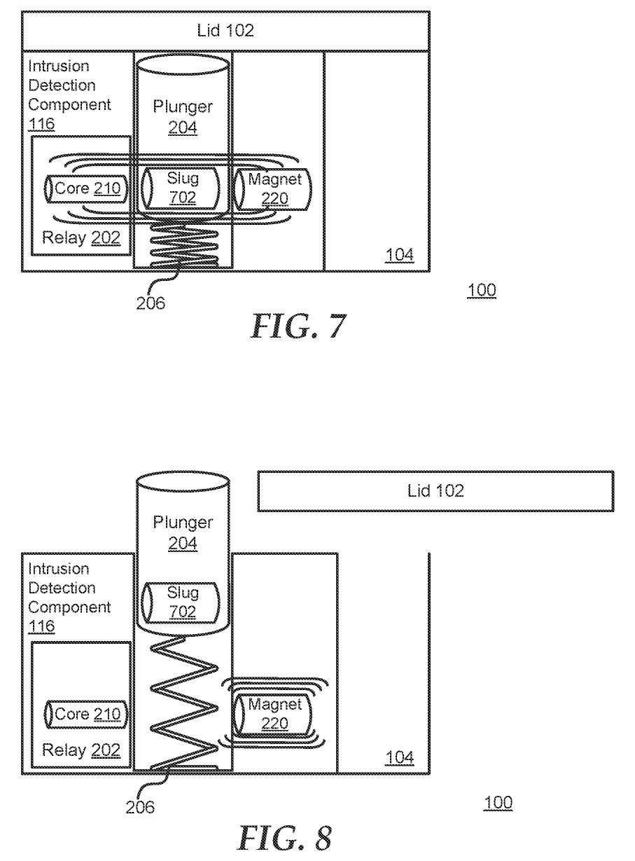

Based on the proximity of magnet 220 with core 210, the magnetic field of the magnet may energize the core. In an example, the energizing of core 210 may cause contacts of relay 202 to close, which in turn may assert the relay. The assertion of relay 202 may be utilized by intrusion detection component 116 to identify that lid 102 has been removed from chassis 104. In an example, the removal of lid 102 may indicate an intrusion into chassis 104 of information handling system 100, which may allow an individual to access components of the information handling system, such as storage devices 110, processor 112, and other components 114 of FIG. 1. Operations of components in intrusion detection component 116 to hold or latch contacts of relay 202 in the closed state will be described with respect to FIGS. 4-6.

FIGS. 4-6 illustrate a portion of intrusion detection component 116 in open and closed states according to at least one embodiment of the present disclosure.Intrusion detection component 116 includes a processor 402, solenoid coils 404 and 406, contacts 408, a switch 410, and magnet 220. Solenoid coils 404 and 406, and switch 410 may be part of a latched relay, such that a relay may hold two stable states without power being provided to the relay. Processor 402 includes multiple terminals, such as first, second, third, and fourth terminals. Solenoid coil 404 includes first and second terminals. Solenoid 406 includes first and second terminals. Contacts 408 include first and second contacts. In an example, the first terminal of processor 402 is electrically coupled to a first contact of contacts 408, the second terminal is electrically coupled to a second contact of contacts 408, the third terminal is electrically coupled to a first terminal of solenoid coil 406, and the fourth terminal is electrically coupled to a second terminal of solenoid coil 406. In certain examples, the first and second terminals of solenoid coil 404 may be no contact terminals, such that the terminals are not connected to another component of intrusion detection component 116. Intrusion detection component 116 may include additional components without varying from the scope of this disclosure. For example, intrusion detection component 116 may include relay 202, plunger 204, and spring 206. However, for clarity and brevity, these components have not been illustrated or described with respect to FIGS. 4-6.

Referring to FIG. 4, when a lid is located on a chassis of an information handling system, such as lid 102 on chassis 104 of information handling system 100 in FIG. 2, magnet 220 may be located away from solenoid coil 404 and the magnet may not have a strong enough magnetic field to energize the solenoid coil. In an example, solenoid coil 404 may be substantially similar to core 210 of FIG. 2. Based on solenoid coil 404 not being energized, switch 410 may be open and contacts 408 may not be asserted. In an example, when contacts 408 are not asserted and switch 410 is open, processor 402 may determine that the lid is on the chassis of the information handling system. As stated above with respect to FIG. 2, magnet 220 is located away from solenoid coil 404 when the plunger is in the retracted position.

Referring to FIG. 5, in response to the lid being removed from the chassis, such as lid 102 and chassis 104 of FIG. 3, magnet 220 may move within intrusion detection component 116 and be placed substantially near solenoid coil 404. As stated above with respect to FIG. 3, magnet 220 is located near solenoid coil 404 when the plunger is in the extended position.

Based on the proximity of magnet 220 with solenoid coil 404, the magnetic field of the magnet may energize the coil. In an example, the energizing of solenoid coil 404 may cause switch 410 to close. In certain examples, switch 410 may be a mechanical switch and energized solenoid coil 404 may pull the switch toward the coil. In response to switch 410 being closed, contacts 408 may be asserted in a closed state, which in turn may place the relay, such as relay 202 in FIG. 3, in an asserted state. In an example, the assertion of contacts 408 in the closed state may be utilized by processor 402 to identify that the lid has been removed from the chassis.

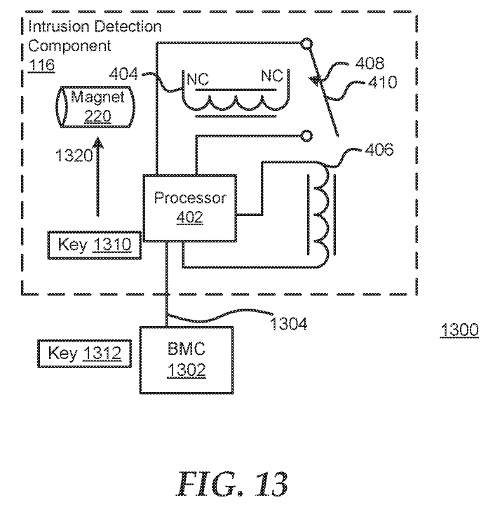

In certain examples, the lid may be replaced on the chassis, and magnet 220 may be pushed away from solenoid coil 404. However, switch 410 may be held in the closed state even without solenoid coil 404 continuing to be energized. After switch 410 has been closed and contacts 408 are asserted in the closed state, the information handling system, such as information handling system 100 in FIG. 1, may be booted. During the boot operations or after the boot operations, a component of the information handling system, such as processor 402 or baseboard management controller (BMC) 1302 of FIG. 13, may read the state of contacts 408. Based on contacts 408 being closed, the component of the information handling system may determine that the lid has been removed and this status may be logged in any suitable memory of the information handling system, such as memory 2020 or 2025 of FIG. 20.

Referring to FIG. 6, after the lid has been replaced and the status has been logged, the state of intrusion detection component 116 may be reset in any suitable manner. For example, processor 402 may provide a current through solenoid coil 406 via the third and fourth terminals. In an example, this current may energize solenoid coil 406 as illustrated by the coil being highlighted or bolded in FIG. 6. In certain examples, the energizing of the coil may release contacts 408 to the open or unasserted state. In certain examples, solenoid coil 406 may be referred to as the release solenoid coil based on the energizing of the coil releases switch 410 and contacts 408.

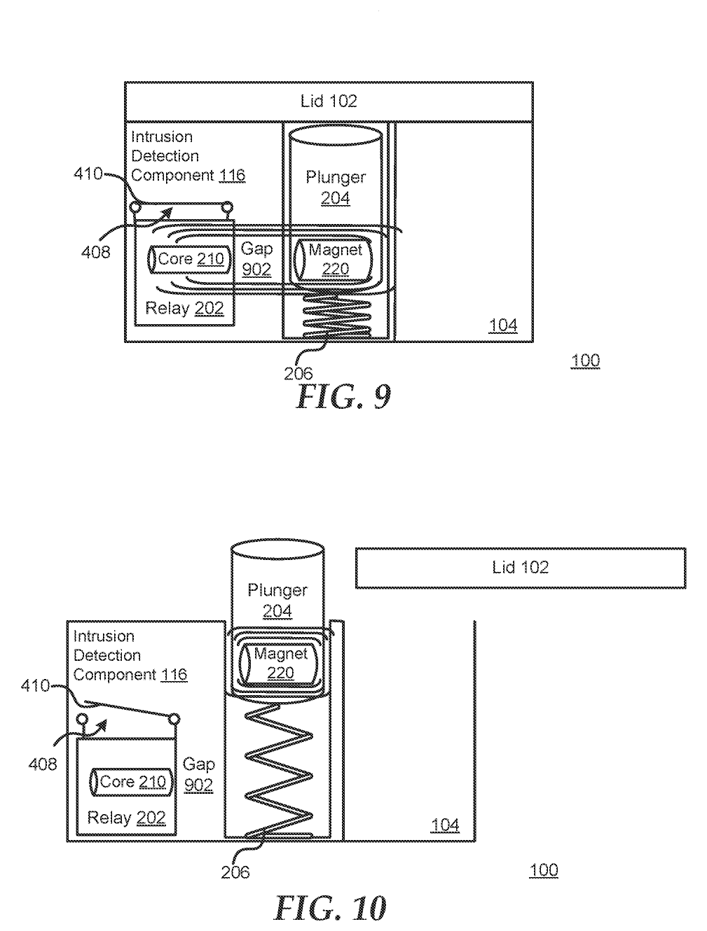

FIGS. 7 and 8 illustrate intrusion detection component 116 in a non-latching configuration according to at least one embodiment of the present disclosure. Intrusion detection component 116 includes a slug 702 within plunger 204, spring 206, core 210 within relay 202, and magnet 220. In an example, slug 702 may be any type of ferrous slug. Intrusion detection component 116 may include additional components without varying from the scope of this disclosure.

In an example, magnet 220 may be located in a section of intrusion detection component 116 that substantially aligned with core 210. However, magnet 220 may be located a particular distance from core 210 such that the magnetic field of the magnet is not strong enough to energize the core. When lid 102 is in the closed state, slug 702 may be aligned with and located between core 210 and magnet 220. In an example, the magnetic field from magnet 220 may not be strong enough to close the contacts of relay 210 through the combination of magnet 220, slug 702, and core 210. The magnetic field of magnet 220 may be strong enough to maintain the contacts of relay 202 in the closed state once they are closed.

In certain examples, a component, such as processor 402 of FIG. 4, may momentarily energize core 210 to close the contacts of relay 202. In response to core 210 being energized, the magnetic field of magnet 220 may be strong enough to maintain the energized state of core 210 even when a current is removed from the core. In an example, the momentarily current within core 210 may induce a magnetic field within the core that may combine with the magnetic field of magnet 220 through slug 702. Therefore, after the current is removed from core 210, a magnetic field will be maintained through the combination of magnet 220, slug 702, and core 210 as illustrated in FIG. 7. This magnetic field may maintain the contacts of relay 202 in the closed or asserted state.

Referring to FIG. 8, in response to lid 102 being removed from chassis 104, spring 206 may exert a force on plunger 204 to move the plunger within the channel in the direction the lid was previously located on the chassis. In this situation, plunger 204 may be located in an extended position and information handling system 100 may be in an open position. While plunger 204 is in the extended position, slug 702 may be no longer located in a position between core 210 of relay 202 and magnet 220.

Based on this location of slug 702, the magnetic field of magnet 220 may no longer be strong enough to energize the core. In this situation, the contacts of relay 202 may open, which in turn may de-assert relay 202. The de-assertion of relay 202 may be utilized by intrusion detection component 116 to identify that lid 102 has been removed from chassis 104. In an example, the removal of lid 102 may indicate an intrusion into chassis 104 of information handling system 100, which may allow an individual to access components of the information handling system, such as storage devices 110, processor 112, and other components 114 of FIG. 1.

In an example, after lid 102 has been replaced, a force is exerted on plunger 204 to push the plunger back to the retracted position. When plunger 204 is back in the retracted position, slug 702 may be aligned between core 210 and magnet 220. However, the magnetic field from magnet 220 may not be strong enough to close the contacts of relay 210 through the combination of magnet 220, slug 702, and core 210. Thus, after relay 202 has been de-asserted based on lid 102 being removed, the relay will remain de-asserted even if the lid is replaced on chassis 104. In this situation, an indication, via relay 202 being de-asserted, of any intrusion into information handling system 100 may be maintained even if the individual replaces lid 102.

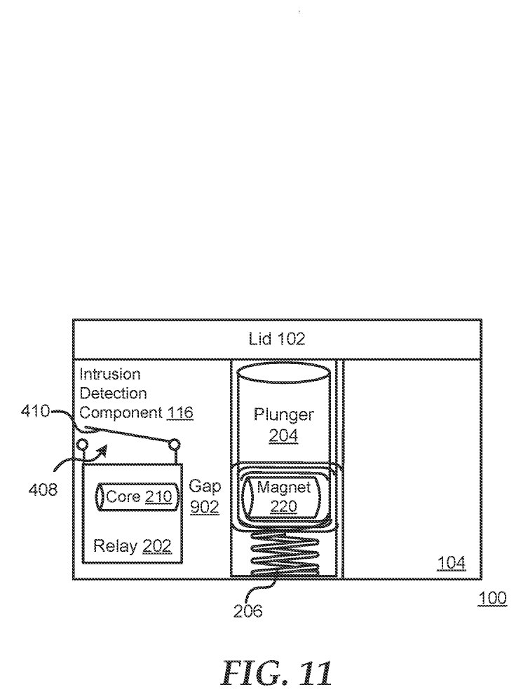

FIGS. 9-11 illustrate intrusion detection component 116 in another non-latching configuration within chassis 104 of information handling system 100 according to at least one embodiment of the present disclosure. In an example, intrusion detection component 116 may be located within chassis 104 such that it is proximate to lid 102. Intrusion detection component 116 includes a defined gap 902, relay 202, plunger 204, spring 206, contacts 408, and switch 410. Defined gap 902 is located between relay 202 and plunger 204, such that a predefined distance separates core 210 from magnet 220. Intrusion detection component 116 may include additional components without varying from the scope of this disclosure.

Referring to FIG. 9, information handling system 100 is in a closed state, such that lid 102 is located on all edges of chassis 104. While lid 102 is in this position, an individual may not be able to access components, such as storage devices 110, processor 112, and other components 114 of FIG. 1, within chassis 104. Based on the location of intrusion detection component 116, the top surface of plunger 204 may be in physical contact with the bottom surface of lid 102 when the lid is closed on chassis 104.

In an example, plunger 204 and spring 206 may be located within a channel of intrusion detection component 116. In this example, spring 206 may be located between the bottom of the channel and the bottom surface of plunger 204. While lid 102 is located on chassis 104, plunger 204 may be in the retracted position such that spring 206 is compressed. In certain examples, spring 206 may exert a force on plunger 204 in the direction of lid 102. However, lid 102 may hold or force plunger 204 to remain in the retracted position while the lid is closed on chassis 104. While plunger 204 is in the retracted position, magnet 220 may be aligned with core 210. However, magnet 220 may not have a strong enough magnetic field to energize core 210 over the distance created by gap 902.

Based on the magnetic field from magnet 220 not being strong enough to energize core 210, gap 902 may prevent the magnet from closing the contacts of relay 210. However, the magnetic field of magnet 220 may be strong enough to maintain the contacts of relay 202 in the closed state once they are closed. In certain examples, a component, such as processor 402 of FIG. 4, may momentarily energize core 210 to close switch 410 on contacts 408 of relay 202. In response to core 210 being energized, the magnetic field of magnet 220 may be strong enough to maintain the energized state of core 210 across gap 902 even when a current is removed from the core. In an example, the momentarily current within core 210 may induce a magnetic field within the core that may combine with the magnetic field of magnet 220. Therefore, after the current is removed from core 210, a magnetic field will be maintained between magnet 220 and core 210 over gap 902 as illustrated in FIG. 9. This magnetic field may maintain switch 410 and contacts 408 of relay 202 in the closed or asserted state.

Referring to FIG. 10, in response to lid 102 being removed from chassis 104, spring 206 may exert a force on plunger 204 to move the plunger within the channel in the direction the lid was previously located on the chassis. In this situation, plunger 204 may be located in an extended position and information handling system 100 may be in an open position. While plunger 204 is in the extended position, magnet 220 may be no longer located in a position to be aligned with core 210 of relay 202.

Based on this location of magnet 220, the magnetic field of the magnet may no longer energize core 210. In this situation, switch 410 and contacts 408 of relay 202 may open, which in turn may de-assert relay 202. The de-assertion of relay 202 may be utilized by intrusion detection component 116 to identify that lid 102 has been removed from chassis 104. In an example, the removal of lid 102 may indicate an intrusion into chassis 104 of information handling system 100, which may allow an individual to access components of the information handling system, such as storage devices 110, processor 112, and other components 114 of FIG. 1.

Referring to FIG. 11, after lid 102 has been replaced, a force is exerted on plunger 204 to push the plunger back to the retracted position. When plunger 204 is back in the retracted position, magnet 220 may be aligned with core 210. However, the magnetic field from magnet 220 may not be strong enough to close switch 410 and contacts 408 of relay 210 over the distance of gap 902. Thus, after relay 202 has been de-asserted based on lid 102 being removed, the relay will remain de-asserted even if the lid is replaced on chassis 104. In this situation, an indication, via relay 202 being de-asserted, of any intrusion into information handling system 100 may be maintained even if the individual replaces lid 102.

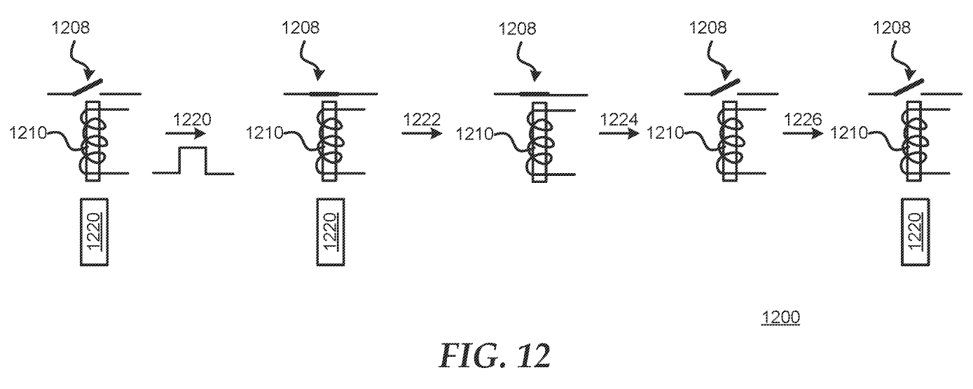

FIG. 12 is a sequence of steps 1200 during an intrusion detection in an information handling system according to at least one embodiment of the present disclosure. Steps 1200 may include different actions by a magnet 1220, a solenoid coil 1210, and a switch 1208. In an example, magnet 1220 may be substantially similar to magnet 220, solenoid coil 1210 may be substantially similar to solenoid coil 404 of FIG. 4.

At an initial step 1220, magnet 1220 may be placed near or proximate to solenoid coil 1210. However, the magnetic field of magnet 1220 may not be strong enough to energize solenoid coil 1210. Based on solenoid coil 1210 not being energized, switch 1208 may remain in an open position. Based on the magnetic field of magnet 1220 not being strong enough to energize solenoid coil 1210, a BMC or other processor may provide a pulse current to the solenoid coil at step 1222. In an example, the current may be a short pulse to briefly or momentarily energize solenoid coil 1210.

At step 1224, the energized solenoid coil 1210 may create a magnetic field, which in turn may close switch 1208. In response to the magnetic field from solenoid coil 1210, the magnetic field of magnet 1220 may be strong enough to hold or maintain the solenoid coil in the energized state. Based on solenoid coil 1210 being maintained in the energized state, switch 1208 may be held in the closed or asserted state.

At step 1226, magnet 1220 is removed from close proximity to solenoid coil 1210. In an example, magnet 1220 may be removed from near solenoid coil 1210 in any suitable manner. For example, a lid of an information handling system may be removed from the chassis of the information handling system. In this example, the removal of the lid may cause a plunger to move to an extended position, which in turn may move magnet 1220 away from solenoid coil 1210. In response to magnet 1220 being removed from close proximity to solenoid coil 1210, the solenoid coil will no longer be energized. In this situation, switch 1208 may transition from the closed or asserted state to the open or de-asserted state at step 1218.

At step 1220, magnet 1220 may be moved near solenoid coil 1210. In an example, magnet 1220 may be place near solenoid coil 1210 in any suitable manner. For example, the lid of the information handling system may be placed back on the chassis. In this example, the replacement of the lid may cause the plunger to move to a retracted position, which in turn may move magnet 1220 toward solenoid coil 1210. However, the magnetic field of magnet 1220 may not be strong enough to energize solenoid coil 1210. Based on solenoid coil 1210 not being energized, switch 1208 may remain in an open position.

FIG. 13 illustrates a portion of an information handling system 1300 including intrusion detection component 116 and BMC 1302 according to at least one embodiment of the present disclosure. Intrusion detection component 116 includes magnet 220, processor 402, solenoid coils 404 and 406, contacts 408, and switch 410. BMC 1302 may be electrically coupled to processor 402 via a cable 1304. Cable 1304 may be both a power cable and a data cable for intrusion detection component 116. In an example, processor 402 may be any suitable type of processor, such as a small microprocessor in communication with the relay of intrusion detection component 116. Information handling system 1300 and intrusion detection component 116 may include additional components without varying from the scope of this disclosure.

During an initial boot of information handling system 1300, BMC 1302 may provide an authorization key 1310 to processor 402 via cable 1304. In response to receiving key 1310, processor 402 may store the key in any suitable memory. In an example, the memory associated with processor 402 may be any non-volatile memory, such as a non-volatile flash memory or the like. After providing key 1310 to processor 402, BMC 1302 may store a matching key 1312 in a memory associated with the BMC. In an example, key 1312 may be stored in a non-volatile memory associated with BMC 1302.

In an example, a lid of information handling system 1300 may be removed from the chassis of the information handling system. In this situation, magnet 220 may be moved in the direction of arrow 1320 to be located in close proximity to solenoid coil 404. When magnet 220 is located near solenoid coil 404, the magnetic field of the magnet may energize the coil. In an example, the energizing of solenoid coil 404 may cause switch 410 to close. In certain examples, switch 410 may be a mechanical switch and energized solenoid coil 404 may pull the switch toward the coil. In response to switch 410 being closed, contacts 408 may be asserted in a closed state, which in turn may place the relay, such as relay 202 in FIG. 3, in an asserted state. In an example, the assertion of contacts 408 in the closed state may be utilized by processor 402 to identify that the lid has been removed from the chassis. In certain examples, the lid may be removed while information handling system 1300 is powered down. In this situation, magnet 220 may still energize solenoid coil 404, which in turn will cause contacts 408 to be in the closed or asserted state. Thus, intrusions into information handling system 1300 may be detected while the information handling system is not powered on.

On a next boot of information handling system 1300, processor 402 and BMC 1302 may perform multiple operations to determine whether an intrusion into the information handling system occurred. In an example, BMC 1302 may transmit a status request to processor 402 over cable 1304. In certain examples, the status request may be for key 1310 and relay contact status of contacts 408. In response to the status request, processor 402 may determine whether contacts 408 are in the open or de-asserted state or the closed or asserted state. Processor 402 may provide the determined state of contacts 408 and key 1310 to BMC 1302.

In response to receiving the state or status of contacts 408 and key 1310, BMC 1302 may perform multiple operations to determine whether an intrusion occurred within information handling system 1300. In an example, BMC 1302 may first compare received key 1310 to key 1312 stored in a memory associated with the BMC. If received key 1310 does not match stored key 1312, BMC 1302 may determine that cable 1304 or intrusion detection component 116 have been tampered. In an example, if intrusion detection component 116 has been switched out, received key 1310 will not match stored key 1312. If cable 1304 has been cut or disconnected, received key 1310 will not match stored key 1312.

In an example, if received key 1310 matches stored key 1312, BMC 1302 may determine whether an intrusion has occurred based on the status or state of contacts 408. If the status of contacts 408 is open or de-asserted, BMC 1302 may determine that the lid has not been removed and no intrusion has occurred. However, if the status of contacts 408 is closed or asserted, BMC 1302 may determine that the lid has been removed and an intrusion has occurred. In certain examples, if the lid is removed while information handling system 1300 is powered on and operational, processor 402 may immediately provide the closed or asserted state of contacts 408 to BMC 1302. In an example, if intrusion detection component 116 is in a non-latching configuration, BMC 1302 may determine that an intrusion has occurred when contacts 408 and switch 410 in the open or de-asserted state.

In certain examples, an individual associated with information handling system 1300 may want to reset the state of contacts 408. In this situation, the individual may utilize BMC 1302 to reset contacts 408 to the open or de-asserted state. In an example, BMC 1302 may provide a reset command to processor 402. In response to receiving the reset command, processor 402 may provide an authorization key request to BMC 1302. Based on the key request, BMC 1302 may provide key 1312 to processor 402. In an example, BMC 1302 may provide key 1312 in the reset command such that processor 402 does not need to request the key.

Processor 402 may compare key 1312 to key 1310 to determine whether the reset command is valid and whether the relay contacts may be reset. If key 1312 matches key 1310, processor 402 may validate the reset command. In this situation, processor 402 may energize solenoid coil 406 to reset contacts 408 and switch 410 to the open or de-asserted state. In an example, if intrusion detection component 116 is in a non-latching configuration, processor 402 may briefly re-energize solenoid coil 404 to place contacts 408 and switch 410 to the closed or asserted state. If key 1312 does not match key 1310, processor 402 may determine that the reset command is not valid. Based on the reset command not being valid, processor 402 may deny the reset command and not reset contacts 408 and switch 410.

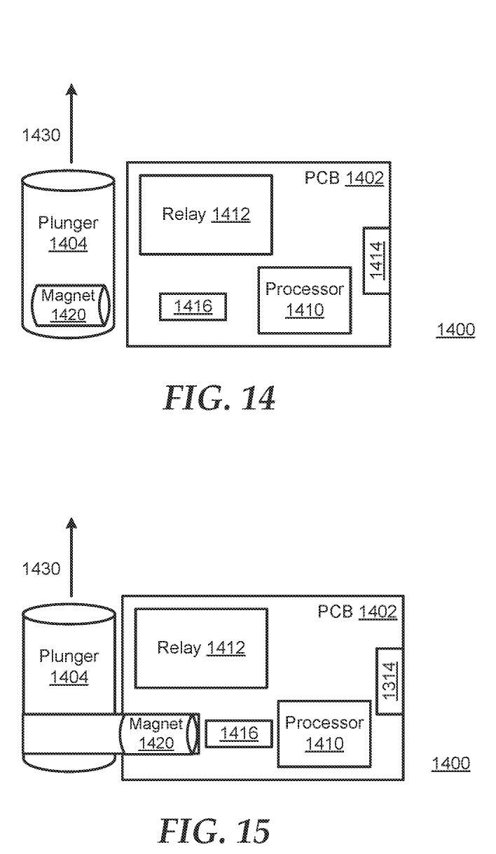

FIGS. 14-17 illustrate a portion of an information handling system 1400 according to at least one embodiment of the present disclosure. Information handling system 1400 includes a printed circuit board (PCB) 1402 and a plunger 1404. In an example, PCB 1402 may be substantially similar to intrusion detection component 116 described above. Plunger 1404 may be substantially similar to plunger 204 described above. PCB 1402 includes a processor 1410, a relay 1412, a connector 1414, and a relay driver 1416. Plunger 1404 includes a magnet 1420. Information handling system 1400 and PCB 1402 may include additional components without varying from the scope of this disclosure.

In an example, processor 1410 may utilize relay driver 1416 to control one or more components of relay 1412. For example, processor 1410 may control relay driver 1416 to energize a solenoid coil of relay 1412 to de-assert contacts and open a switch of the relay. In certain examples, connector 1414 may interface with a cable to enable processor 1410 to communicate with a BMC of information handling system 1400.

Referring to FIGS. 14 and 15, plunger 1404 and magnet 1420 are in a latching style, such that the magnet energizes a solenoid coil within relay 1412 when a lid is removed from information handling system 1400. For example, when the lid is removed plunger 1404 may move in the direction of arrow 1430 and magnet 1420 may energize the solenoid coil of relay 1412 to latch the contacts of the relay in a closed or asserted position.

In certain examples, plunger 1404 and magnet 1420 may have different configurations. For example, plunger 1404 may include magnet 1420 within the plunger, such that the magnet is located on the side of PCB 1402 and relay 1412, as illustrated in FIG. 14. In another configuration, plunger 1404 may include an extension portion to place magnet 1420 over PCB 1402 and relay 1412 as illustrated in FIG. 15. In an example, the configuration of plunger 1404 with magnet 1420 over PCB 1402 may have a greater assembly thickness as compared to the configuration of the plunger with the magnet on the side of the PCB. In this example, the assembly thickness may be increased by the thickness of magnet 1420.

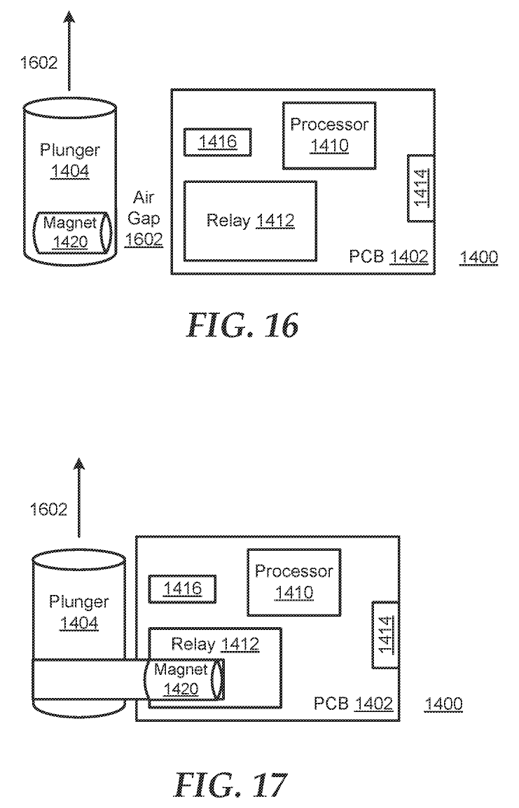

Referring to FIGS. 16 and 17, plunger 1404 and magnet 1420 are in a non-latching style, such that the magnet no longer energizes a solenoid coil within relay 1412 when a lid is removed from information handling system 1400. For example, when the lid is removed plunger 1404 may move in the direction of arrow 1602 and magnet 1420 may move away from the solenoid coil of relay 1412. In this situation, the magnetic field of magnet 1420 may not be strong enough to energize the solenoid coil of relay 1412, such that the contacts of the relay may transition to an open or de-asserted position.

In certain examples, plunger 1404 and magnet 1420 may have different configurations. For example, plunger 1404 may include magnet 1420 within the plunger, such that the magnet is located on the side of PCB 1402 and relay 1412 with an air gap between the magnet and the PCB, as illustrated in FIG. 16. In another configuration, plunger 1404 may include an extension portion to place magnet 1420 over PCB 1402 and relay 1412 with an air gap between the relay and the magnet as illustrated in FIG. 17. In an example, the configuration of plunger 1404 with magnet 1420 over PCB 1402 may have a greater assembly thickness as compared to the configuration of the plunger with the magnet on the side of the PCB. In this example, the assembly thickness may be increased by the thickness of magnet 1420 and the amount of air gap between the magnet and PCB 1402.

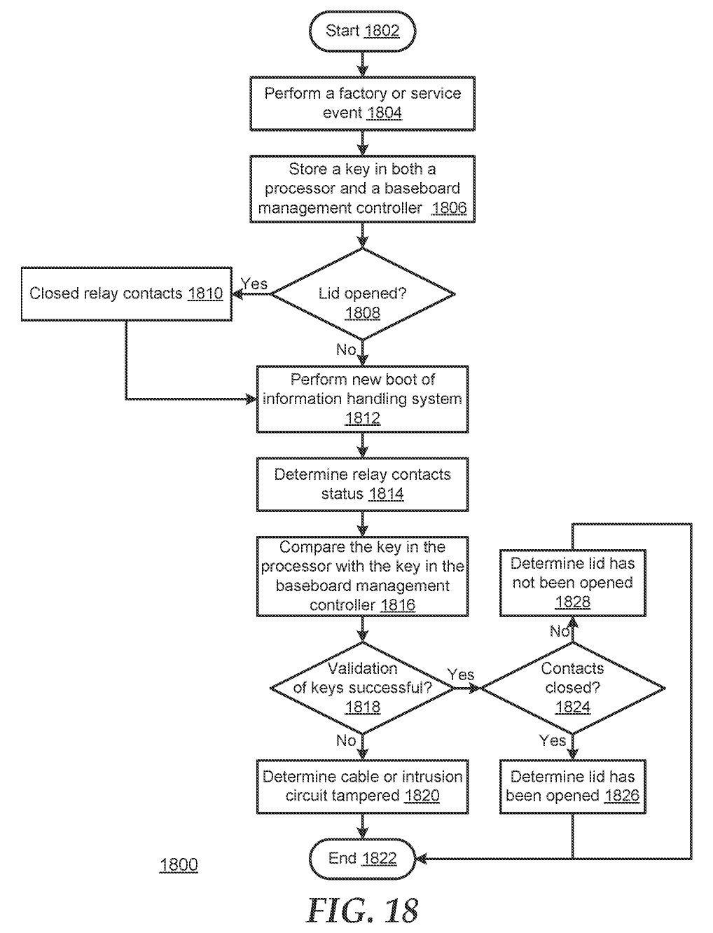

FIG. 18 shows a method 1800 for determining whether an intrusion of an information handling system has occurred according to at least one embodiment of the present disclosure, starting at block 1802. Not every method step set forth in this flow diagram is always necessary, and certain steps of the methods may be combined, performed simultaneously, in a different order, or perhaps omitted, without varying from the scope of the disclosure. FIG. 18 may be employed in whole, or in part, by processor 402 and BMC 1302 of FIG. 12, or any other type of controller, device, module, processor, or any combination thereof, operable to employ all, or portions of, the method of FIG. 18.

At block 1804, a factory or service event is performed. In an example, the information handling system may be any suitable device, such as a server, a storage device, or the like. At block 1806, a key is stored in both a processor and a baseboard management controller (BMC) during the factory or service event. In certain examples, the processor may be part of an intrusion detection component and the key may be stored in a memory or cache associated with the processor. In an example, the BMC may be external to the instruction detection circuit and located in another region of the information handling system. The key may be stored in a memory associated with the BMC. The processor and the BMC may be in electrical communication via any suitable cable, such as a power and data cable.

At block 1808, a determination is made whether a lid of the information handling system has been opened. In an example, the intrusion detection component may perform any suitable operations to determine whether the lid of the information handling system has been opened. For example, intrusion detection component may be a latching relay circuit, a non-latching relay circuit, or the like. Depending on the configuration of intrusion detection component, a plunger of the intrusion detection component may cause a magnet to provide a magnetic field to a core of the relay which in turn may energize the core to cause contacts of a switch to close. If the lid has not been opened the flow continues at block 1812. If the lid has been opened, relay contacts are closed at block 1810. While intrusion detection component is described herein as closing the relay contacts in response to the lid being opened, the contact may be opened in response to the lid being opened without varying from the scope of this disclosure.

At block 1812, a new boot of the information handling system is performed. In certain examples, the new boot of the information handling system may be at any suitable point in time. For example, the boot may occur before the lid has been opened, after the lid has been opened, after the lid has been opened and reclosed, or the like. At block 1814, the relay contacts status is determined. In an example, the status of the contacts is either open or closed. In certain examples, the contacts status identifies that the lid has either been opened.

At block 1816, a comparison is made between the key in the processor and the key in the BMC. In an example, the comparison may be made either in the processor or in the BMC. At block 1818, a determination is made whether the key in the processor matches the key in the BMC. If the key in the processor does not match the key in the BMC, a determination is made that cable between the processor and the BMC has been tampered with or the intrusion detection component has been replaced at block 1820 and the flow ends at block 1822. In an example, the key associated with the processor may be stored a volatile memory. In this example, when power is lost to the intrusion detection component, the key may be erased such that the determination at block 1818 may be that no match exits between keys of the BMC and the processor. In certain examples, the power may be lost by the cable between the processor and the BMC being cut, the cable being shorted, the intrusion detection component being replaced, or the like.

If the key in the processor matches the key in the BMC, a determination is made whether the relay contacts are closed at block 1824. In an example, the processor of the intrusion detection component may perform the determination of whether the relay contacts are closed. This determination may be made in any suitable manner, such as whether a short is detected across the contacts, whether a current flows through the relay, or the like.

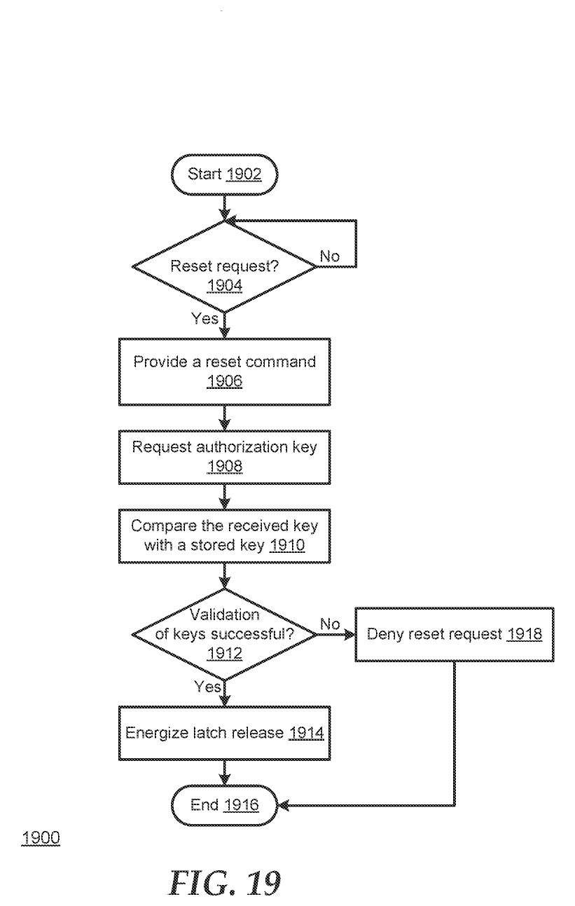

If the relay contacts are closed, a determination is made that the lid has been opened at block 1826 and the flow ends at block 1822. If the relay contracts are not closed, a determination is made that the lid has not been opened at block 1828 and the flow ends at block 1822. In an example, after the contacts have closed based on the lid being opened, the contacts will remain closed even if the lid is put back on the information handling system. If the intrusion detection component is in a non-latching configuration, the determination that the lid has been opened may be based on the contacts and the switch being the open or de-asserted state. In certain examples, the BMC may communicate with the processor of the intrusion detection component to reopen the contacts as will be described with respect to FIG. 19 below.

FIG. 19 shows a method 1900 for resetting relay switch in intrusion detection componentry of an information handling system according to at least one embodiment of the present disclosure, starting at block 1902. Not every method step set forth in this flow diagram is always necessary, and certain steps of the methods may be combined, performed simultaneously, in a different order, or perhaps omitted, without varying from the scope of the disclosure. FIG. 19 may be employed in whole, or in part, by processor 402 and BMC 1302 of FIG. 12, or any other type of controller, device, module, processor, or any combination thereof, operable to employ all, or portions of, the method of FIG. 19.

At block 1904, a determination is made whether a reset request has been received. In an example, the reset request may be received at a BMC of an information handling system, and the request may be provided by a user of the information handling system. In certain examples, the reset request may be associated with resetting the contacts of a relay in the intrusion detection component. In response to the reset request being made, a reset command is provided at block 1906. The BMC may provide the reset command. In an example, the reset command may be received by a processor of an intrusion detection component of the information handling system.

At block 1908, an authorization key is requested. In certain examples, the processor may provide an authorization key request to the BMC. The processor may utilize the received authorization key to determine whether the reset command is valid and whether the relay contacts may be reset. In an example, the contacts are reset by the processor causing the relays to change states, such as from a closed state to an open state, or from the open state to the closed state.

At block 1910, the received authorization key is compared to a stored authorization key. In certain examples, the stored authorization key may be located in a memory associated with the processor of the intrusion detection component. For example, the stored authorization key may be located in a cache of the processor. At block 1912, a determination is made whether the received authorization key is validated. The validation of the received authorization key based on the stored authorization key may be performed through any suitable operations executed in the processor.

If the received authorization key is validated, a latch release is energized at block 1914 and the flow ends at block 1916. In response to the latch release being energized, the contacts of a switch in the intrusion detection component may transition from a closed state to an open state or from the open state to the closed state. If the received authorization key is not validated, is reset request is denied at block 1918 and the flow ends at block 1916. Based on the reset request being denied, the contacts may remain in the closed state, such that the intrusion detection component may maintain that the lid of the information handling system has been opened or removed.

FIG. 20 shows a generalized embodiment of an information handling system 2000 according to an embodiment of the present disclosure. Information handling system 2000 may be substantially similar to information handling system 102 of FIG. 1. Further, information handling system 2000 can include processing resources for executing machine-executable code, such as a central processing unit (CPU), a programmable logic array (PLA), an embedded device such as a System-on-a-Chip (SoC), or other control logic hardware. Information handling system 2000 can also include one or more computer-readable medium for storing machine-executable code, such as software or data. Additional components of information handling system 2000 can include one or more storage devices that can store machine-executable code, one or more communications ports for communicating with external devices, and various input and output (I/O) devices, such as a keyboard, a mouse, and a video display. Information handling system 2000 can also include one or more buses operable to transmit information between the various hardware components.

Information handling system 2000 can include devices or modules that embody one or more of the devices or modules described below and operates to perform one or more of the methods described below. Information handling system 2000 includes a processors 2002 and 2004, an input/output (I/O) interface 2010, memories 2020 and 2025, a graphics interface 2030, a basic input and output system/universal extensible firmware interface (BIOS/UEFI) module 2040, a disk controller 2050, a hard disk drive (HDD) 2054, an optical disk drive (ODD) 2056 , a disk emulator 2060 connected to an external solid state drive (SSD) 2064, an I/O bridge 2070, one or more add-on resources 2074, a trusted platform module (TPM) 2076, a network interface 2080, a management device 2090, and a power supply 2095. Processors 2002 and 2004, I/O interface 2010, memory 2020, graphics interface 2030, BIOS/UEFI module 2040, disk controller 2050, HDD 2054, ODD 2056, disk emulator 2060, SSD 2064, I/O bridge 2070, add-on resources 2074, TPM 2076, and network interface 2080 operate together to provide a host environment of information handling system 2000 that operates to provide the data processing functionality of the information handling system. The host environment operates to execute machine-executable code, including platform BIOS/UEFI code, device firmware, operating system code, applications, programs, and the like, to perform the data processing tasks associated with information handling system 2000.

In the host environment, processor 2002 is connected to I/O interface 2010 via processor interface 2006, and processor 2004 is connected to the I/O interface via processor interface 2008. Memory 2020 is connected to processor 2002 via a memory interface 2022. Memory 2025 is connected to processor 2004 via a memory interface 2027. Graphics interface 2030 is connected to I/O interface 2010 via a graphics interface 2032 and provides a video display output 2036 to a video display 2034. In a particular embodiment, information handling system 2000 includes separate memories that are dedicated to each of processors 2002 and 2004 via separate memory interfaces. An example of memories 2020 and 2030 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 2040, disk controller 2050, and I/O bridge 2070 are connected to I/O interface 2010 via an I/O channel 2012. An example of I/O channel 2012 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 2010 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 2040 includes BIOS/UEFI code operable to detect resources within information handling system 2000, to provide drivers for the resources, initialize the resources, and access the resources. BIOS/UEFI module 2040 includes code that operates to detect resources within information handling system 2000, to provide drivers for the resources, to initialize the resources, and to access the resources.

Disk controller 2050 includes a disk interface 2052 that connects the disk controller to HDD 2054, to ODD 2056, and to disk emulator 2060. An example of disk interface 2052 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 2060 permits SSD 2064 to be connected to information handling system 2000 via an external interface 2062. An example of external interface 2062 includes a USB interface, an IEEE 4394 (Firewire) interface, a proprietary interface, or a combination thereof. Alternatively, solid-state drive 2064 can be disposed within information handling system 2000.

I/O bridge 2070 includes a peripheral interface 2072 that connects the I/O bridge to add-on resource 2074, to TPM 2076, and to network interface 2080. Peripheral interface 2072 can be the same type of interface as I/O channel 2012 or can be a different type of interface. As such, I/O bridge 2070 extends the capacity of I/O channel 2012 when peripheral interface 2072 and the I/O channel are of the same type, and the I/O bridge translates information from a format suitable to the I/O channel to a format suitable to the peripheral channel 2072 when they are of a different type. Add-on resource 2074 can include a data storage system, an additional graphics interface, a network interface card (NIC), a sound/video processing card, another add-on resource, or a combination thereof. Add-on resource 2074 can be on a main circuit board, on separate circuit board or add-in card disposed within information handling system 2000, a device that is external to the information handling system, or a combination thereof.

Network interface 2080 represents a NIC disposed within information handling system 2000, on a main circuit board of the information handling system, integrated onto another component such as I/O interface 2010, in another suitable location, or a combination thereof. Network interface device 2080 includes network channels 2082 and 2084 that provide interfaces to devices that are external to information handling system 2000. In a particular embodiment, network channels 2082 and 2084 are of a different type than peripheral channel 2072 and network interface 2080 translates information from a format suitable to the peripheral channel to a format suitable to external devices. An example of network channels 2082 and 2084 includes InfiniBand channels, Fibre Channel channels, Gigabit Ethernet channels, proprietary channel architectures, or a combination thereof. Network channels 2082 and 2084 can be connected to external network resources (not illustrated). The network resource can include another information handling system, a data storage system, another network, a grid management system, another suitable resource, or a combination thereof.

Management device 2090 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 2000. In particular, management device 2090 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 2000, such as system cooling fans and power supplies. Management device 2090 can include a network connection to an external management system, and the management device can communicate with the management system to report status information for information handling system 2000, to receive BIOS/UEFI or system firmware updates, or to perform other task for managing and controlling the operation of information handling system 2000.

Management device 2090 can operate off of a separate power plane from the components of the host environment so that the management device receives power to manage information handling system 2000 when the information handling system is otherwise shut down. An example of management device 2090 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 2090 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An intrusion detection component for an information handling system, the intrusion detection component comprising:
a relay including:
a switch including a plurality of contacts; and
a core coupled to the switch;
a magnet to selectively energize the core of the relay; and
a plunger located in proximity to the relay, the plunger to change whether the magnet is in a position to energize the core, in response a transition of the plunger from a retracted position to an extended position, the relay to change a state of the contacts in the switch, wherein the change of the state indicates an intrusion into the information handling system.

2. The intrusion detection component of claim 1, further comprising:
a slug located within the plunger, wherein the slug is aligned with the core and with the magnet when the plunger is in the retracted position.

3. The intrusion detection component of claim 2, wherein the slug enables the magnet to energize the core when the slug is aligned with the core and with the magnet.

4. The intrusion detection component of claim 1, wherein the magnet is located within the plunger and the magnet energizes the core when the plunger is in the retracted position.

5. The intrusion detection component of claim 4, wherein a magnetic field between the core and the magnet collapses when the plunger is in the extended position.

6. The intrusion detection component of claim 1, wherein the magnet is located within the plunger, wherein an air gap exists between the plunger and the relay, wherein a current is applied to the core to energize the core and create a magnetic field between the core and the magnet when the plunger is in the retracted position.

7. The intrusion detection component of claim 1, further comprising: a processor in communication with the contacts of the switch, wherein the processor is configured to determine whether the contacts are a closed state or an open state.

8. The intrusion detection component of claim 7, wherein the processor to determine whether the intrusion has occurred based on the state of the contacts.

9. An information handling system comprising:
a chassis;
a processor located within the chassis;
a memory located within the chassis;
a lid in communication with the chassis, wherein physical access to the processor and the memory is enabled when the lid is opened; and
an intrusion detection component in proximity to the lid, the intrusion detection component includes:
a relay having:
a switch including a plurality of contacts; and
a core coupled to the switch;
a magnet to selectively energize the core of the relay; and
a plunger located in proximity to the relay, the plunger to change whether the magnet is in a position to energize the core, in response a transition of the plunger from a retracted position to an extended position, the relay to change a state of the contacts in the switch, wherein the change of the state indicates an intrusion into the information handling system.

10. The information handling system of claim 9, wherein the contacts are in a first state after the lid has been opened, and the contacts are in a second state when the lid has not been removed.

11. The information handling system of claim 10, wherein the contacts remain in the first state when the lid has been opened and the lid is replaced on the chassis.

12. The information handling system of claim 9, wherein the intrusion detection component further comprises: a processor in communication with the contacts of the switch, wherein the processor is configured to determine whether the contacts are a closed state or an open state.

13. The information handling system of claim 12, wherein the processor further to store a first authentication key.

14. The information handling system of claim 13, further comprising:
a baseboard management controller to communicate with the processor of the intrusion detection component, the baseboard management controller to store a second authentication key, in response to a boot of the information handling system, the baseboard management controller to:
retrieve the first authentication key from the processor;
compare the first authentication key to the second authentication key; and
in response to the first authentication key and the second authentication key not matching, determine the intrusion into the information handling system has occurred.

15. The information handling system of claim 9, further comprising:
a slug located within the plunger, wherein the slug is aligned with the core and with the magnet when the plunger is in the retracted position.

16. The information handling system of claim 15, wherein the slug enables the magnet to energize the core when the slug is aligned with the core and with the magnet.

17. A method comprising:
requesting, by a baseboard management controller of an information handling system, a first authentication key from a processor of an intrusion detection component of the information handling system;
comparing, by the baseboard management controller, the first authentication key to a second authentication key, wherein the second authentication key is stored within the baseboard management controller; and
in response to the first authentication key not matching the second authentication key, determining that an intrusion occurred within the information handling system.

18. The method of claim 17, further comprising:
determining a state of contacts in a switch of the intrusion detection component;
in response to the contacts being in a first state, determining that a lid of the information handling system has been opened; and
in response to the contacts being in a second state, determining that the lid of the information handling system has not been opened.

19. The method of claim 17, wherein the intrusion includes the intrusion detection component being swapped for a previous intrusion detection component.

20. The method of claim 17, wherein the intrusion includes a cable between the intrusion detection component and the baseboard management controller being shorted.
